(19) United States
(12) Patent Application Publication
(10) Pub. No.: US 2011/0266091 A1
(43) Pub. Date: Nov. 3, 2011

(54) ANIMAL POWER GENERATOR

(76) Inventor: William Taylor, Macosquin (GB)

(21) Appl. No.: 12/921,394

(22) PCT Filed: Mar. 9, 2009
(86) PCT No.: PCT/GB2009/050231

§ 371 Date: Mar. 23, 2011

(30) Foreign Application Priority Data
Mar. 7, 2008 (GB) 0804292.1

(51) Int. Cl. F03G 5/02

(52) U.S. Cl. 185/16

(57) ABSTRACT

A treadmill power generator (10) comprises an upwardly inclined treadmill (2) having an entry end (16c) and a feed end (16b). A belt constitutes the treadmill and rotates around rollers (8,12). Side barriers (16a) prevent an animal on the belt from exiting the treadmill sideways. A releasable brake holds the belt in a fixed position. A detector (22) detects the head of an animal entering the feed end (16b) and releases the brake, whereby the animal must continue to walk in order for its head to remain at the feed end. Its walking drives the belt and rotates the roller against the resistance of a generator (50) to generate electricity, or other farm equipment mechanical or hydraulic load.

This invention relates to the generation of power, particularly electricity, by animals, especially cattle. The present invention particularly relates to a large type of treadmill cubicle for use in generating power using livestock whilst they are housed, for example, over the winter months.

### BACKGROUND

In winter, in many temperate and colder climates, cattle and other livestock need to be housed to avoid the effects of the cold and wet, and because grass in the fields ceases to grow. The cattle are fed using stored food such as silage.

Renewable energy is the current buzz phrase, there can surely be no energy more renewable than that which is completely untapped in the muscles of cattle. This invention seeks to harness a fair and reasonable amount of that energy by having the animals walk on an elevated tread mill belt while eating thus generating power via the carrier roller shaft assembly's at the front or rear (or both) of the tread mill belt.

### PRIOR ART

DE-A-19533534 and KR-A-2002-0065786 both disclose an electrical generator for converting movement energy in fitness training into electricity, and potentially employs a treadmill.

EP-A-1416615 and WO-A-2007/090922 both disclose a rotary power generator driven by animals (horses) using a vertical axis generator and horizontally disposed turning levers which the horses drive to rotate the generator. Presumably, they need human attention to keep them driving.

US-A-20050161289 discloses an elaborate mechanism using horses walking on an upwardly inclined treadmill-type arrangement to generate electricity.

DE-U-202005002613 discloses an exercise treadmill for animals having a feeding end which, when the animal enters that area, presents food and drink for the animal but also commences the treadmill so that the animal has to walk in order to remain in contact with the food and drink.

WO-A-85/04073 discloses an inclined treadmill for exercising horses. Likewise U.S. Pat. No. 7,363,60 discloses an arrangement with an inclined treadmill to exercise horse on shipboard and other places, and U.S. Pat. No. 5,114,390 shows a similar arrangement for exercising sheep.

It is an object of the present invention to improve upon the prior art arrangements.

### BRIEF SUMMARY OF THE DISCLOSURE

In accordance with a first aspect of the present invention there is provided a treadmill power generator comprising:
a treadmill having an entry end and a feed end;
a belt comprising the treadmill and rotating around a roller;
side barriers, so that an animal on the belt cannot exit the treadmill sideways;
a detector to detect the head of an animal entering the feed end;
a load driven by the roller and providing resistance to rotation of the roller;
wherein the detector comprises a biased lever that prevents the animal reaching the feed end unless it is engaged by the animal, whereby the animal must continue to walk in order for its head to remain at the feed end, its walking driving the belt and rotating the roller against the resistance of the load.

In accordance with a second aspect of the present invention there is provided a treadmill power generator comprising:
An upwardly inclined treadmill having an entry end and a feed end;
a belt comprising the treadmill and rotating around a roller;
side barriers, so that an animal on the belt cannot exit the treadmill sideways;
a brake to hold the belt in a fixed position;
a detector to detect the head of an animal entering the feed end;
a load driven by the roller and providing resistance to rotation of the roller;
wherein the detector releases the brake when it detects an animal, whereby the animal must continue to walk in order for its head to remain at the feed end, its walking driving the belt and rotating the roller against the resistance of the generator.

Preferably the load is an electricity generator. A flywheel may be interposed between the roller and the load in order to smooth the rotation of the load.

Said side barriers with said feed end may form a cubicle. Indeed, the animal may regard the cubicle as a feed cubicle.

Preferably, the treadmill comprises two large end rollers, free to rotate and fitted with tension adjustment means for the belt. A plurality of adjacent antifriction rollers may form a carrier table for the belt. Preferably, the belt is a cleated conveyor belt.

With the arrangement of the second aspect of the present invention, when the animal enters the treadmill and wants to feed, its head goes forward towards a feed box, thus activating the detector and releasing the brake. Its continued walking drives the treadmill and generates power. When full or no longer desirous of eating, the animal will stop walking. The belt will continue to move withdrawing the animal from the head end. As its head leaves the feed end, it deactivates the detector and thus brakes the treadmill belt, giving stability for the animal to complete the reversing out process.

It should be noted that, depending on how the animals are being fed, entry to the cubicle can be restricted. Preferably, the entry end has a sensor-operated entry gate. Preferably, animals in the vicinity are identified by the sensor, whereby the gate is opened if the animal is to be permitted to feed. An ID chip may be attached to each animal that the sensor detects, for example via a neck collar or ear tag.

The generation of power by the animal in the second aspect is achieved by raising the treadmill cubicle at the feed end to facilitate the required angle or slope on the treadmill belt. This could be done hydraulically or mechanically. Indeed, the cubicle may be fitted both with pallet fork sleeves and adjustable front legs, whereby the angle of inclination may be adjusted. The slope of the cubicle and belt will determine the happy balance between extracting the maximum power from the animal and the safe limit not to over burden the animal. The pallet fork sleeves would also permit transportation of the cubicle.

Preferably, a governor is fitted to control the speed of rotation of the roller within limits. The governor may control operation of a clutch and, optionally, a gearbox between the roller and generator. The flywheel, when present, may be disposed next to the governor or wherever it is strategically required.

Preferably, a plurality of treadmills are arranged in parallel, whereby a number of cows during housing time could operate several treadmills a large percentage of every 24 hours, thereby providing substantial output of electrical power.

Alternatively, in accordance with the first aspect of the invention, the treadmill is not upwardly inclined. In this case (but also potentially in the case described above in which it is upwardly inclined), the detector comprises a biased lever that prevents the animal reaching the feed end unless it is engaged by the animal, and, after actuation thereof and when the animal stops walking, the lever has sufficient bias to push the animal away from the feed end and to drive the treadmill until the brake is applied by return of the lever.

Said bias may be spring bias. Said detector may comprise a shoulder collar movably supported between said side barriers. Preferably, said collar is linked to a feed box of the cubicle it from a remote position beyond the feed end of the cubicle towards said feed end. Preferably, said feed box is slidably disposed on bars on the side barriers, said link preferably comprising a cable around a pulley on one end of said bar.

### BRIEF DESCRIPTION OF THE DRAWINGS

Embodiments of the invention are further described hereinafter, by way of example, with reference to the accompanying drawings, in which:

FIG. 1 is a perspective view of a treadmill cubicle assembly according to the invention;

FIG. 2 is a plan view of several treadmill cubicle assemblies according to the invention connected together;

FIG. 3 is a side view of a preferred alternative embodiment of the invention; and,

FIG. 4 is a view in the direction of the Arrow X in FIG. 3.

### DETAILED DESCRIPTION

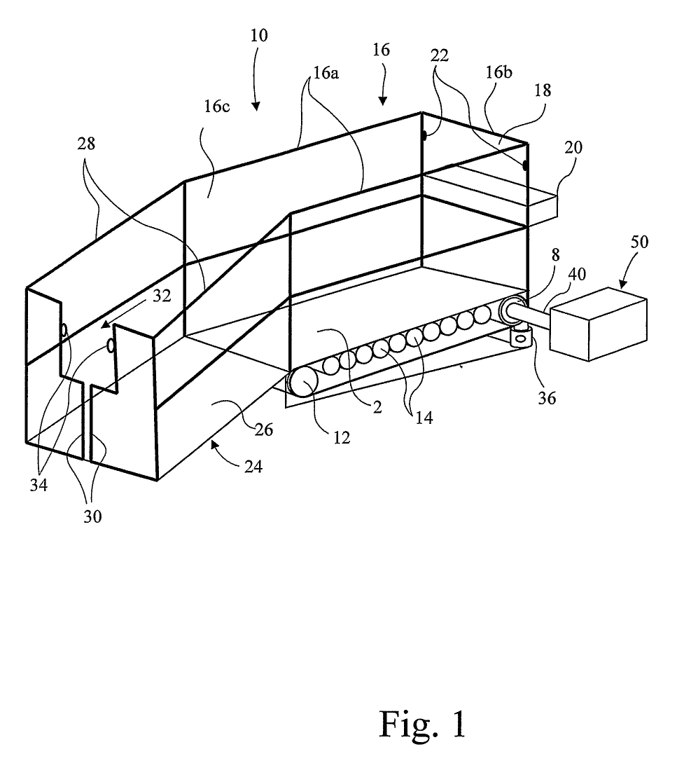

In FIG. 1, which is not drawn to scale, a treadmill electricity generator 10 is a the steel framed cubicle 16 having inside a treadmill belt 2, forming its floor, and wound around two large end rollers 8,12. Under the belt 2 are numerous small belt carrier rollers 14 between the end rollers 8,12 and supporting the belt 2. Alternatively, these rollers 14 could be substituted by a ball bearing table (not shown).

The cubicle 16 comprises side barriers 16a, a closed feed end 16b, and an open entry end 16c. The feed end 16b has an opening 18 through which an animal wishing to feed may insert its head to feed (and optionally drink) from a hopper 20. A detector 22 is positioned in the opening 18 to detect when an animal (not shown) has thrust its head through the opening. This may trigger delivery of a quantity of food into the hopper 20, or access to food already there.

The open entry end 16c may be protected by a gate system 24, comprising a slatted ramp 26 (or possibly a step or steps—not shown), side barriers 28, and a central-opening gate 30. Indeed, the gate 30 may have a head-space 32 provided with sensors 34. When an animal wants to gain entry and thrusts its head into the head space 32, the sensors 34 sense a label (ie neck collar or ear tag) carried by the animal. The label may be an integrated circuit chip of well known construction that identifies the particular animal to a central computer (not shown). It may be that the animal meets criteria that causes the computer to allow the gate 30 to open. Indeed, the detectors 22 may be of the same type as the sensors 34, so that the system checks that the animal feeding is the same as the animal that opened the gate. Food might not be dispensed in the case that the animal is not due to be fed. In which event, it would soon lose interest and back out of the treadmill. On the other hand, while it continues to walk, there would be no harm in its continuing to generate electricity and indeed, it may do so until such time as it meets the required criteria for feeding. The criteria might simply be time-based, but might also be based on calculations of the electricity generated by that particular animal.

The floor 2 is inclined upwardly, so that gravity causes the floor to move under the animal's weight, and obliging the animal to walk if it wants to maintain position in the cubicle 16.

After entering on the static treadmill cubicle belt, to get fed, the animal will walk forward to the food placed in hopper 20 with head going forward the animal will trigger the sensor 22 thereby activating the release of electromagnetic clutch and brake. At this point the animal will feel the belt attempt to move it away from its food due to the cubicle slope (and its body weight) artificially created by adjustable front jack legs, 36 and therefore begin to walk to correct its eating position thus generating power safely limited to its body weight and strength.

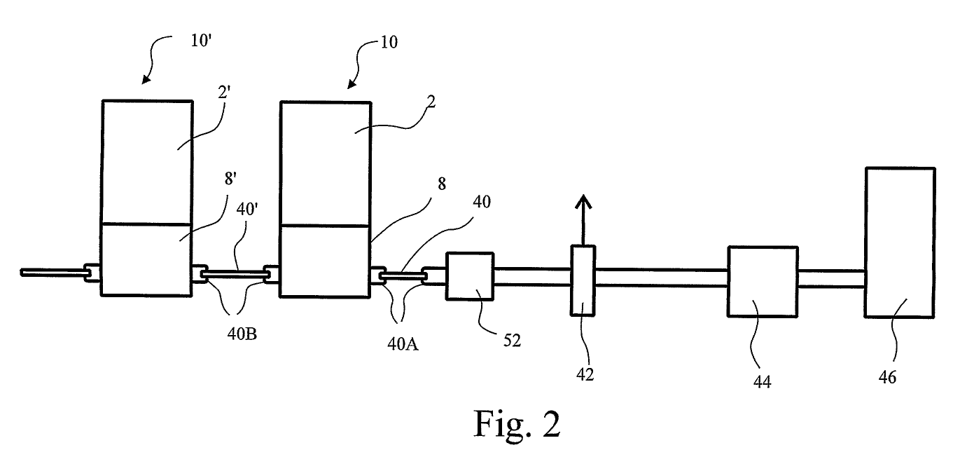

The power now generated can join (perhaps already turning) shaft 40. For example, a ratchet and pawl mechanism might allow shaft 40 to turn inside roller 8 when the roller 8 is stationary, but to add to the drive of shaft 40 when the roller is released and permitted to turn relative to the cubicle 10. Thus several cubicles could be connected in parallel, as shown schematically in FIG. 2.

The end of the series of shafts 40 may include a speed governor 42, for limiting speed of the rotation of the shaft train 40, and a flywheel 52 to smooth rotation. A gearbox 44 may be driven by the governor, which may in turn drive a generator 46, all together shown as item 50 in FIG. 1. The electricity generated could of course used by the farm with potentially any surplus being sold to the national power generators, as presently exists with other forms of renewable power generation. However, equally within the scope of the present invention is the possibility to directly couple the driven shaft 40 to other farm machinery including hydraulic equipment, whereby the load driven by the treadmill(s) is not a generator (or only a generator), but mechanical or hydraulic machinery. Indeed, although all the load is shown from a single shaft train 40′40′, there is no reason why an electricity generator 50 could not be arranged as shown, but some other power take off coupling (not shown) be provided on the other roller 12. Indeed, a separate power train could connect adjacent entry end rollers 12. In that respect, those may be the rollers selected to provide the main drive (if there is only one) which, apart from anything, has the advantage that no angular adjustment of the shaft train, or corresponding raising and lowering of the load 50, is required at that end in order to accommodate the adjustment of the inclination of the treadmill 2.

Given that the angle of inclination is adjustable, the shaft 40 may be provided with universal joints 40a, 40b, so that its height (and therefore angle of inclination) may be adjusted without having to adjust the position of the elements 50 (42,44,46 in FIG. 2) or without necessarily adjusting the position of adjacent treadmills 10′. Indeed, some automatic adjustment of the angle of inclination may be implemented using the jacks 36 and under the control of the computer (not shown). For example, if particularly strong animals are admitted, then the angle of inclination may be increased, whereas if the animals are less strong, it may be lowered.

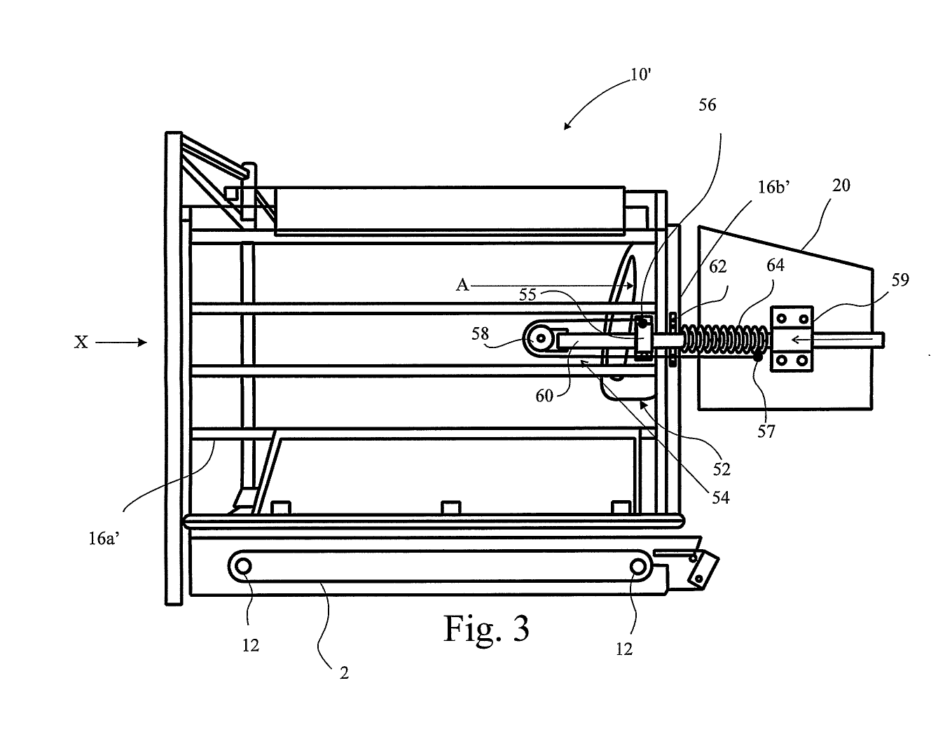

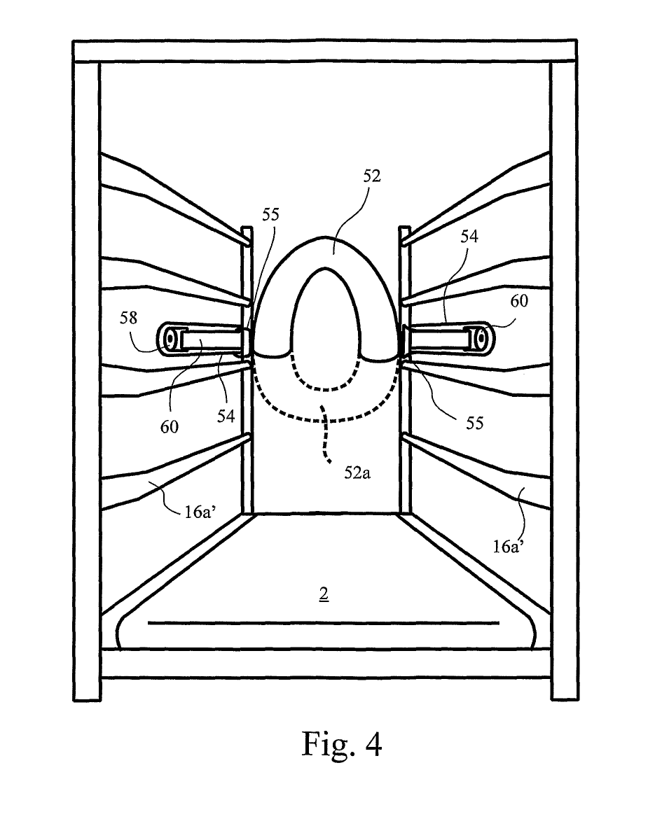

Turning to FIG. 3, a preferred alternative arrangement is shown. It is preferred because the floor provided by the treadmill conveyor 2 is here horizontal, which will suit many animals better than an inclined floor. However, in order to force the animal to walk while it feeds from the feed box 20, it must push against spring-loaded shoulder collar 52. As shown in FIG. 3, the collar is a complete ring through which the animal inserts its head, but any arrangement might be provided that achieves the desired function. Thus, it may be an open collar having a V- or U-shape when viewed from the front or rear, and the V- or U- may be inverted (see FIG. 4, in which the collar 52 is shown as an inverted V-shape, but with the possibility of a full ring shown at 52a).

The collar is padded to protect the animal. It has sleeves 55 on either side that slide on bars 60 that are fixed in the cubicle, one on either side parallel to the side walls 16a′. The bars 60 are fixed, for example, by a bracket 62 of the end frame 16b′. A cable or wire rope 54 is connected to the collar by a stud 56 and wound around a pulley 58. Its other end is connected by a stud 57 to feed box 20. The pulley is disposed on the end of the bars 60. On the bars is also slidably disposed the feed box 20, via sleeve brackets 59. When the animal presses against the collar 52, the collar moves rightwardly in the drawing to the position shown. In doing so, the feed box 20 is drawn by the cable 54 leftwardly (in the drawing) towards the end frame, compressing springs 64 on the bars 60 between a sleeve 66 on the feed box 20 and through which the feed box is mounted on the bars 20, and the end frame 16b′. The collar therefore acts as a lever that prevents the animal reaching the feed end of the cubicle 10′ unless it is engaged by the animal.

However, should the animal stop walking, the springs 64, push the feed box away from the frame 16b′ while the cable 54 pushes the animal back via the collar 52. The animal may resist and push on the conveyor against the collar 52, but, if it does not walk, the conveyor 2 nevertheless falls back until the animal can no longer access the feed box 20.

If the animal has finished feeding, it does not object. Eventually, the collar returns to its start position (not shown) in which a brake on the conveyor is actuated to lock it and facilitate the animal's exit from the cubicle. If it has not finished feeding, however, it must renew its walking efforts, pushing against the collar 52, if it wants to remain in contact with the feed box. The conveyor is thereby driven and can be employed as above to generate electricity.

Instead of, or in addition to the mechanical coil springs 64, hydraulic or pneumatic springs and dampers may be employed. Indeed, control of the strength of the spring might be employed whereby the force required to be used by the animal to bring the feed box into feeding position may be varied. Such control may be provided by a computer system (not shown) that might be linked to the specific identity of the animal in question which (in this event) will be tagged so that the computer system recognises it. Thus, as described above, the computer system might recognise an animal approaching the cubicle and determine that it has not fed recently and may be permitted to feed (some more), whereupon the entry gate is opened. Initially, the system may require only light pressure on the collar 52 to bring the food forward, but then increase the pressure required which then obliges the animal to press harder. This has the consequence of increasing the pressure on the conveyor and therefore its speed.

Indeed, the pressure required might also be connected to the load on the conveyor. For example, in a multi-stall environment, if there are many animals already in place and the load is small (because, for example, there is no current requirement for electricity) then perhaps even the entry gate is not, at least initially, opened; but if it is opened (for example if the animal has not fed for some time), the pressure required might be varied from little (because that is all the animal is able to exert given the small load on the conveyor and the conveyor's consequent ability to move with little pressure applied to it) and a larger load to increase the speed of rotation of the conveyor and thereby training the animal to move faster while feeding.

Also the pressure to be applied might be determined to some extent by the specific animal itself. That is, if the system knows the animal is powerful then a greater pressure may be required of it, whereby it will drive the conveyor faster and do more work. Conversely, a young or smaller animal my not be required to work so hard in order to get its food. It is not beyond the skill of the computer system designer to develop a system that takes the foregoing considerations into effect.

Finally, if the deck of the conveyor 2 is flat, then the need for a brake may be removed—an unbraked flat conveyor may have sufficient stability to enable safe boarding and disembarking of the animal from the stall. In any event, it should be understood that the features of the embodiments of FIGS. 1, 2 and 3 can be combined. Thus, the conveyor may still be slightly inclined even in the case of the arrangements described with reference to FIG. 3.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. The reader's attention is directed to all papers and documents which are filed concurrently with or previous to this specification in connection with this application and which are open to public inspection with this specification, and the contents of all such papers and documents are incorporated herein by reference. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A treadmill power generator comprising:
a treadmill adapted for an animal to walk upon, the treadmill rotatably positioned around at least one roller;
the treadmill further comprising an entry end and a feed end;
the feed end defining a head-space opening and an animal feed hopper, the head-space opening adapted to permit an animal to insert its head therethrough to feed at the feed hopper;
at least two side barriers adapted and positioned to prevent an animal on the belt from exiting the treadmill sideways;
a detector adapted to detect the head of an animal entering the feed end through the head space opening;
the detector further comprising a biased lever adapted to prevent an animal from reaching the feed end unless the lever is engaged by the animal; a load driven by the roller and providing resistance to rotation of the roller;
wherein the detector prevents the animal reaching the feed end unless it is engaged by the animal, whereby the animal must engage the lever by continuing to walk on the treadmill in order for its head to remain at the feed the animal's walking driving the belt and rotating the roller against the resistance of the load.

2. A treadmill power generator comprising:
an upwardly inclined treadmill adapted for an animal to walk upon, the treadmill rotatably positioned around at least one roller;
the treadmill further comprising a treadmill brake adapted to hold the treadmill still unless activated;
the treadmill still further comprising an entry end and a feed end;
at least two side barriers adapted and positioned to prevent an animal on the belt from exiting the treadmill sideways;
the brake configured to hold the belt in a fixed position until it is activated;
a detector adapted to detect the head of an animal entering the feed end, and further adapted to activate the brake and release the treadmill;
a load driven by the roller and providing resistance to rotation of the roller;
wherein the detector releases the brake when it detects an animal, whereby the animal must continue to walk in order for its head to remain at the feed end, its walking driving the belt and rotating the roller against the resistance of the load.

3-23. (canceled)
